(19) United States
(12) Patent Application Publication
(10) Pub. No.: US 2017/0301173 A1
(43) Pub. Date: Oct. 19, 2017

(54) VENDING MACHINE

(71) Applicant: BUBBLY GROUP AS, Oslo (NO)

(72) Inventors: Kim HINDSGAUL, Oslo (NO); Thomas André Eidal BLICHFELDT, Oslo (NO)

(73) Assignee: BUBBLY GROUP AS, Oslo (NO)

(21) Appl. No.: 15/513,487

(22) PCT Filed: Sep. 23, 2015
(86) PCT No.: PCT/NO2015/050168

§ 371 Date: Mar. 22, 2017

(30) Foreign Application Priority Data
Sep. 23, 2014 (NO) 20141151

(51) Int. Cl. G07F 11/02; G06K 9/62; G07F 17/00; G07F 9/02; A47F 10/00; G06K 9/00

(52) U.S. Cl. CPC G07F 11/02; G07F 17/0014; G07F 9/026; G06K 9/62; G06K 9/00; A47F 10/00

(57) ABSTRACT

A vending machine for selling or dispensing products or items to a user may include a container for storing and displaying the products. The container may have a transparent portion making the products visible from outside the container, and an aperture for removing one or more products by hand, wherein the aperture gives direct access to the products. An aperture access enabling device may selectively enable or prevent access through the aperture into the container. Finally, a recognition module for recognizing each of the products in the container, may include at least one module selected from the group consisting of: a camera based object recognition module, a weight recognition module, and an RFID recognition module. Also described are methods of operating the vending machine.

### BACKGROUND OF THE INVENTION

Current vending machines are usually bulky. This kind of vending machines are usually permanently installed at places such as train stations, subway stations etc. The different and separated compartments of this kind of vending machines are filled with different products. The vending machine is programmed accordingly, such that an article is delivered from a certain compartment depending on a choice made by a user/customer. Due to their size, the places of installation are limited for such vending machines. Also, the range of products is limited to the ones the vending machine can deal with from a mechanical point of view.

Examples of such vending machines are described in Norwegian patent 311908 B and European patent application 2 634 755 A, both of which disclose vending machines with mechanisms for dispensing and delivery of products involving relatively intricate mechanisms for, respectively, display of products, dispensing of product to a chamber or drawer, and access to the chamber or drawer for removal of the product. These features make the machines bulky, heavy, and limited to products that are consistent with the capabilities of the dispensing mechanisms.

Thus, there is a need for a vending machine providing more flexibility with respect to places of installation and range of products.

### SUMMARY OF THE INVENTION

The invention provides a vending machine which addresses the above mentioned need, and the vending machine and method for operating a vending machine according to the independent claims may provide an improvement in flexibility with respect to installation places and product range. Further advantageous developments are subject of the dependent claims.

A vending machine for selling or dispensing products or items to a user in accordance with the principles of the invention may include a container for storing and displaying the products. The container may have a transparent portion making the products visible from outside the container, and an aperture for removing one or more products by hand. An aperture access enabling device may selectively enable or prevent access through the aperture into the container. Finally, a recognition module for recognizing each of the products in the container, may include at least one module selected from the group consisting of: a camera based object recognition module, and a weight recognition module. The aperture gives direct access to the products.

In particular, the recognition module may be a processor or a part of the processor together with operating software. The vending machine according to this embodiment can provide high flexibility with respect to placement and products. The fact that the user can pick the products himself makes it possible to omitting complex and expensive means for dispensing the products, resulting in a lightweight vending machine which is compact and cost efficient. It provides a high flexibility with respect to the products that can be delivered, because the products do not have to fit inside product specific compartments or dispensing mechanisms. The recognition module supports this flexibility as it can recognize a large variety of products and it is easily adaptable to new products by simply supplying the recognition module with a comparison sample of the new product. The compact size and less complex design of the vending machine also provide an advantageous marketing platform.

According to one aspect of the invention, the vending machine can be provided with at least one camera, wherein the recognition module comprises at least a camera based object recognition module which is operatively connected with the camera. The camera based object recognition module is adapted to recognize products by comparing output data from the camera, including at least one of a shape, a color and an imprint, with data stored in a sample storage in the memory of or accessible to the recognition module. In this manner reliable recognition can be provided while at the same time avoiding the necessity of preparing the sold products by arranging them in separate containers, tagging them or employing other physical means of distinguishing one product from another.

According to another aspect of the invention the vending machine may further comprise a network communication device for operatively connecting the vending machine with a remote server. The communication with the remote server may make it easy to centrally change the prices of the products because the server can provide the vending machines with current prices. It can also be centrally determined which vending machines need to be refilled when the vending machines communicate the remaining products to the server, etc. Also, the communication device may be wireless, further facilitating flexible placement of the vending machine, because it reduces the need for installation of cables.

In one embodiment of the invention, the vending machine has only a single aperture for removing one or more products. Having only a single aperture reduces complexity of the device and ensures that all products are leaving the vending machine through the same aperture such that the recognition may be focused to this one aperture.

According to one aspect, the aperture access enabling device is a piston which closes the aperture by telescopically extending out from a cylindrical guidance towards or into the aperture and which opens the aperture by telescopically retracting from its extended state. The piston as aperture access enabling device provides a robust closing mechanism for the vending machine, it is big enough to allow the integration of a camera, and it has an attractive appearance.

According to yet another aspect of the invention, the aperture access enabling device may comprise a light barrier device for selectively establishing one or more light beams as a light barrier and for detecting an interruption of at least one of this one or more light beams, and an alarm device for outputting an alarm signal if such an interruption is detected. In embodiments including this aspect, the number of moving parts are reduced which lead to lower manufacturing cost and less maintenance.

According to another aspect of the invention, a vending machine according to the invention may include a user interface by means of which a user is identifiable. The identification of the user may facilitate various payment solutions and discourage theft of products, because it may make it possible to determine who took what from the machine. It also enables user data acquisition for marketing purposes and for providing the user with additional benefits, such as personalized coupons. Further, the user identification ensures a quick purchase of products without requiring cash money.

A user interface may include at least one of a touch screen, a tablet computer, a keyboard, a card reader, a camera, a fingerprint reader and a user communication device for communicating with a mobile device operated by the user. Such a user interface may be adapted to identify the user by means of face recognition, which allows a very quick recognition without the user being required to enter a password etc.

According to yet another aspect of the invention, the entire space inside the container, which space is adapted for storing the products, may be a single undivided space. While it is possible to divide the container into a plurality of spaces for separation or sorting of the different products or items that are stored inside, this is not necessary. As a consequence, refilling the machine can be done in an easy and fast manner, because the products may simply be dumped into the container while the lid is removed. The undivided space does not require stacking of products in a certain manner or to stick each product into a specific place. It also provides flexibility with respect to the range of products, because the size and shape of the products is of less relevance compared to the vending machines with mechanisms for holding and dispensing individual items.

According to another aspect of the invention, a method for operating a vending machine for selling or dispensing products to a user, is provided. The vending machine may comprise a container for storing and displaying the products, the container having a transparent portion making the products visible from outside the container, and an aperture for removing one or more products by hand, wherein the aperture gives direct access to the products. Such a method may include operating an aperture access enabling device for selectively enabling or preventing access through the aperture into the container, recognizing the products in the container when removed from the container by means of at least one recognition method selected from the group consisting of: a camera based object recognition, and a weight recognition.

In embodiments where the recognition method includes camera based recognition, the camera based object recognition module may recognize the products by comparing output data from the camera with data stored in a memory of the vending machine. The data stored in this memory may include at least one of a shape, a color and an imprint representative of the respective products the machine is configured to recognize. This product recognition enables reliable recognition without making it necessary to tag the products with identification means (e.g. RFID tags) or selectively dispensing products from separate compartments.

According to another aspect of the invention, a user of the vending machine may be identified by at least one identification method selected from the group consisting of: facial recognition, finger print recognition, recognition of a mobile device associated with the user, login via password, login via credit card, login via smart card. A mobile device, e.g. a smartphone or cellphone, may for example be associated with a user by means of the SIM card installed in the device and its association with the user's subscription with a telecom operator, by means of a digital certificate installed on the mobile device, or by means of software installed on the mobile device and configured to represent the user when interacting with networked services.

According to a further aspect of the invention, data collecting data related to the environment of the vending machine, the user and the sold products, and combining these data, thus enabling multiple possibilities of using these data for marketing purposes.

In another aspect the method includes tracking the eyes of the user and/or people passing by the vending machine. Having this kind of information available enables analysis of the attractiveness of packaging, advertisement, products, design etc. Thus, it would give feedback for marketing purposes which could be used for improving marketing, improving placement of the machine etc.

In yet another aspect, the method includes dispensing or delivering coupons from the vending machine which are personalized to the user. The coupons may be delivered as physical printouts from a printer attached to the machine, or electronically in the form of a message sent to a mobile device associated with the user, e.g. in the form of an SMS message, a message internal to a specific app, an e-mail message, or by similar means. The coupon may also be dispensed only to an online account of the user to be stored there and accessed when the user wants to use the coupon. The user interaction of the vending machine enables the vending machine to react on a purchase process with the dispensing of these personalized coupons, which may be positive for satisfying the users.

A method of performing a transaction, e.g. a sale, in a vending machine according to the invention may include such steps as receiving data from the user interface, the input identifying a user, enabling access through the aperture, upon removal of a product from the container, receiving data from the at least one sensor representative of or including the at least one characteristic, issuing a request for confirmation of acceptance of the transaction to the user interface, and upon receiving input from the user interface representing the identified user's acceptance, performing the transaction and preventing access through the aperture.

The user interface may include at least one device chosen from the group consisting of: a camera, a touch screen, a card reader, a user communication device, and an NFC reader, and the data identifying a user may be an image of the user's face, a username and password, data read from a credit card or a smart card, data received from a mobile device associated with the user, data read from an NFC tag associated with the user or data.

In some embodiments of the invention, the aperture access enabling device logically closes the aperture by activating a detector mechanism which is capable of issuing an alarm when detecting that an object is entered through the aperture, for example when a person sticks his hand in through the aperture without prior identification. In other embodiments, the aperture access enabling device physically closes the aperture by activating an actuator that moves a door into a position which partly or fully blocks the aperture. In the latter case, the door may be one of the top of a cylinder or piston which telescopically moves toward the aperture, a hinged door which turns on the hinges into a closed position, and a lid which slides or rotates into a closed position. An iris valve would be a non-limiting example of the latter.

The at least one sensor may be chosen from the group consisting of: a weight sensor, a camera, and an RFID reader. The characteristic may then be a weight, an image representative of an outline, and image representative of a color, an image representative of an imprint, and data read from an RFID tag attached to the product. Any combination of these are, of course, included.

The request for confirmation of acceptance may, for example, be chosen from the group consisting of: a text shown on a display which is part of the user interface, a text which is transmitted over the user interface to a mobile device associated with the identified user.

The input from the user interface may include at least one of credit card information from a card reader, mobile payment information from a mobile device associated with the identified user, information identifying a debit account associated with the identified user, and information confirming the identified user's acceptance to receive one or more messages from a set of messages stored remotely.

The input from the user interface may also include information confirming the identified user's acceptance to receive one or more messages. The messages may be chosen from a subset of the set of messages. The subset may, for example, be messages that are selectable based on criteria associated with the detected at least one characteristic, which is the same as being associated with an identified product or group of products. The message may be a coupon or some other form of advertisement, but it could equally well be a message related to the use of the product, a receipt associated with the transaction etc.

Finally, the processor may also be programmed to perform a payment method. Such a method may include processing the data representative of the detected at least one characteristic to determine the type of product based on comparisons with stored data representative of characteristic features of the types of products stored in the container, including with the request for acceptance a price of the identified product, and include with the performance of the transaction a request that an amount corresponding to the price be transferred from an account associated with the identified user to an account associated with a vendor.

### BRIEF DESCRIPTION OF THE DRAWINGS

FIG. 1 is a three-dimensional view of the vending machine according to an embodiment of the present invention;

FIG. 2 shows the vending machine of FIG. 1 in a three-dimensional view from a different perspective;

FIG. 3 shows a schematic cross-sectional view along a plane which is parallel to a side wall of a container of the vending machine of FIG. 1;

FIG. 4 shows a three-dimensional view from above into a container of the vending machine of FIG. 1;

FIGS. 5a, 5b show a display holder holding a tablet computer as user interface of the vending machine;

FIG. 6 shows schematically the communication ability of the vending machine with a remote server;

FIG. 7 schematically shows a block diagram of a control scheme of the vending machine according to an embodiment of the present invention;

FIG. 8 shows another embodiment of the vending machine according to the present invention;

FIG. 9 shows a further embodiment of the vending machine according to the present invention;

FIG. 10 shows yet another embodiment of the vending machine according to the present invention, and

FIG. 11 illustrates an exemplary method that can be performed by the vending machine operating in accordance with the principles of the invention.

### DETAILED DESCRIPTION OF PREFERRED EMBODIMENTS

The following discloses example methods, apparatus, systems, and articles of manufacture including, among other components, firmware and/or software executed on hardware. It should, however, be noted that the embodiments described are intended to be illustrative and should not be considered as limiting. For example, it is contemplated that any or all of these hardware, firmware, and/or software components could be embodied exclusively in hardware, exclusively in firmware, exclusively in software, or in any combination of hardware, firmware, and/or software, except, of course, that certain components by necessity must have a physical implementation in order to interact with other physical objects. Accordingly, while the following describes example methods, apparatus, systems, and articles of manufacture, the examples provided are not the only ways to implement such methods, apparatus, systems, and articles of manufacture. In particular, certain features and aspects that are described in combination herein do not all have to be present in all embodiments of the invention except to the extent they interact to provide specific functionality. For the sake of brevity and efficiency of disclosure of the invention, however, no attempt is made to describe every permutation and combination of subsets of features in distinct exemplary embodiments. Those with skill in the art will understand how various features may be combined dependent on the set of features and capabilities a particular embodiment should provide.

The present invention is directed to a vending machine for selling or dispensing products such as chocolate bars, beverage cans, beauty articles, snacks, product samples etc. from a closeable container. The users who would like to obtain one or more of these products are identified and the vending machine opens. The user can then pick the desired product himself by hand. The vending machine recognizes automatically which product was removed and bills it automatically to the account of the user. Due to the compact size of the vending machine, it can be placed at many places such as entrances of shops, in offices and waiting rooms.

It should be noted that in more general terms the machine is configured to perform a transaction that includes the delivery of an item to a user. The transaction does not have to be a sale, but for the sake of efficiency of explanation, the following exemplary embodiments will primarily be described as involving sale of items. Except to the extent that payment solutions are explicitly described, each sale is intended to be an example of a transaction, and does not necessarily have to involve transfer of funds.

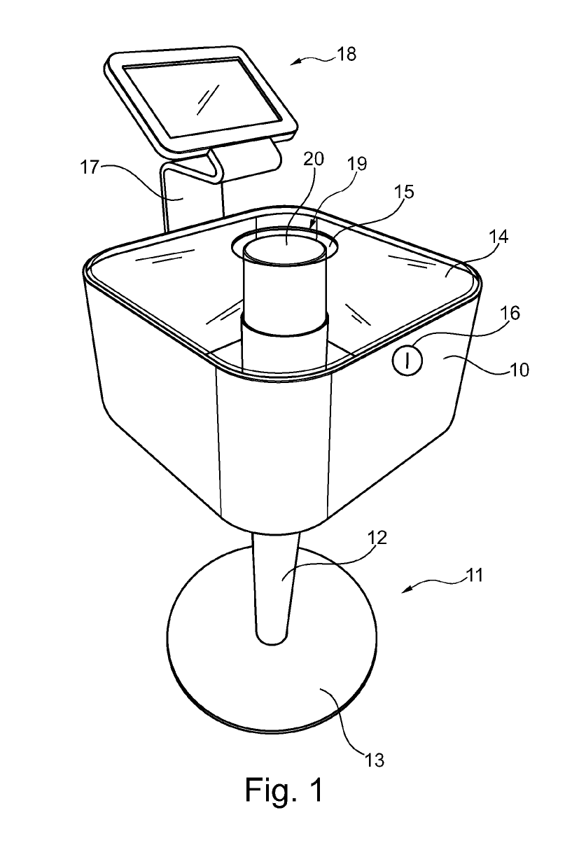

FIG. 1 is a three-dimensional view of a vending machine according to an embodiment of the present invention. The main body of the vending machine is formed by a container 10 which is box-shaped with rounded corners. The containers outer dimensions may in particular be 50 cm×50 cm with a height of 25 cm. This size facilitates placement even in confined spaces, it is user friendly and provides sufficient capacity for many use cases. However, other dimensions are possible and consistent with the principles of the invention, but in order to provide the vending machine with a compact size which fits at a large number of places, the size should be no larger than 100 cm×100 cm with a height of 50 cm. The container 10 is carried by a stand 11 attached to the container 10. The container 10 may be formed of aluminum, white polycarbonate or acrylate polymer. The stand 11 in the embodiment illustrated in FIG. 1 comprises a pole 12 and a round ground plate 13, but other configurations may be contemplated. The upper side of the container 10 is covered with a removable lid 14 which form-fits into an upper opening of the container 10. The lid 14 is transparent and may be formed of polycarbonate or acrylic glass. The lid 14 is curved outwardly such that its height is in particular between 40 and 50 mm, e.g. 44 mm. An aperture 15 is formed centrally in the lid 14 and should be dimensioned large enough for a user to reach inside the container 10 by hand, in particular the diameter of the aperture 15 may be 16 cm, but could also be in the range of 15 cm to 30 cm depending on whether the vending machine is provided with a cooling function, and the size of the products (e.g. for newspapers or books, the aperture may be larger). The aperture is shown as a circular opening, but other shapes may be contemplated.

A lock 16 may be provided for locking and unlocking the lid 14 to/from the container 10. The illustrated lock 16 is of rather schematic nature and illustrated as a mechanical lock, but the invention may also be implemented with an electro-mechanical lock which is operable by means of a wireless key, by a processor, or a specific code entered via a user interface. The processor and the user interface will be described in further detail below. On a back side of the container 10, a display holder 17 may be attached, and the display holder 17 may hold a user interface 18, for example in the form of a tablet computer. If the display holder 17 is needed depends on the kind of user interface 18 used in a particular embodiment. Instead of or in addition to the tablet computer shown in the drawing, the user interface 18 could comprise a user communication device 63 for communicating with a cell phone or a tablet computer belonging to the user, for connecting to some other mobile device, or it may be a card reader or NFC reader for reading a smart or credit card of the user. If the user interface 18 is a user communication device 63 without a display at the vending machine, the display holder 17 may not be necessary. The user communication device 63 may by a radio transmitter/receiver. Instead information may be displayed on the mobile device of the user.

In the embodiment illustrated in FIG. 1, the inside of the container 10 includes an aperture access enabling device 19 or closing device in form of a piston 20 which closes the aperture 15 when telescopically extended out of the upper end of the pole 12 and which opens the aperture 15 when telescopically retracted. Thus, the upper portion of the pole 12 may form a cylinder which is guiding the piston 20, namely the cylindrical outer side of the piston 20 is guided by the cylindrical inner side of the pole 12. Alternatively, there may be provided a separate cylinder for guiding the piston 20, which cylinder is attached to the container 10 or the pole 12. The upper end of the piston 20 reaches into or approximates the aperture 15 and is dimensioned smaller than the aperture 15, e.g. has a smaller diameter, but it should also be dimensioned large enough to avoid that products stored in the container can be removed in a closed state. If the vending machine is provided with a cooling function, then it might be desirable to avoid a gap in between the aperture 15 and the piston 20 or to keep it small.

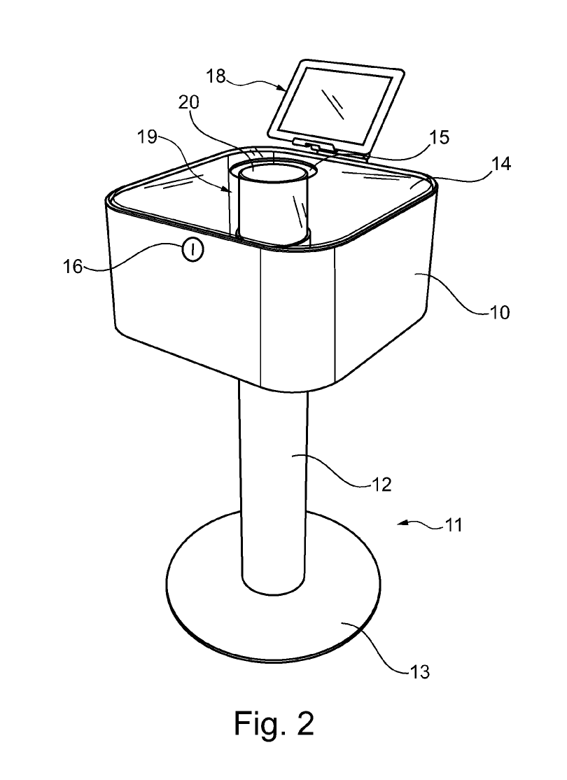

FIG. 2 shows the vending machine according to an embodiment of the present invention in a three-dimensional view from a different perspective.

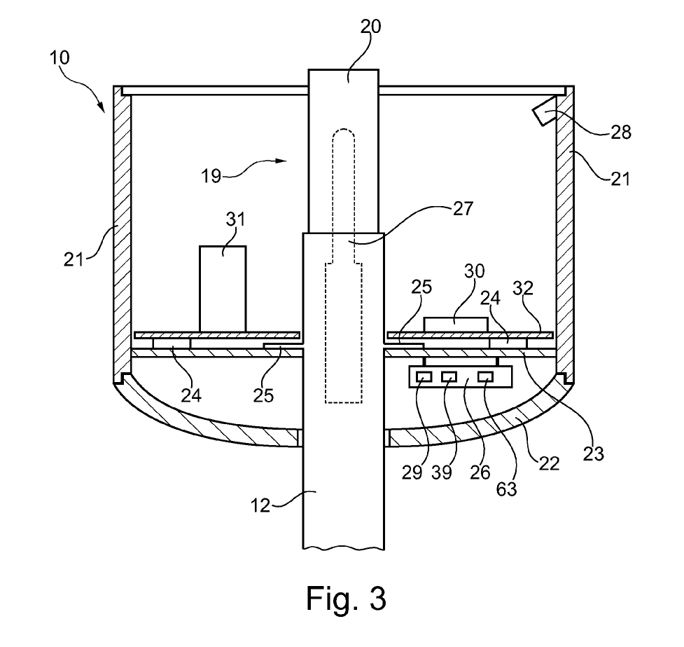

FIG. 3 shows a schematic cross-sectional view along a plane which is parallel to a side wall of the container 10 and between this side wall and the piston 20. The lid 14 is not shown in FIG. 3. The container 10 comprises four side walls 21 which are unitarily and monolithically formed and provided with rounded corners in a top view. A bottom cover 22 is provided. The bottom cover 22 may have the same shape as the lid 14, and it may be made from the same material as the lid 14. In some embodiments the central aperture may have a different size which is adapted to the pole 12 to pass through the bottom cover.

The bottom cover 22 may be removable in order to provide easy access to the inside for maintenance and repair purposes and lockable to the container 10 in a similar manner as the lid 14. Alternatively, the bottom cover 22 may be attached to the lower inner edge of the container 10 by adhesive. Also, the bottom cover 22 can be attached to the pole 12 or a base plate 23. The base plate 23 is either formed unitarily and monolithically with the side walls 21 or attached thereto with known means (e.g. adhesive, screws, snap-fit connections). The base plate 23 can be attached to a flange 25 of the pole 12 (e.g. adhesive, screws, snap-fit connections). The base plate 23 is carrying weight sensors 24 which are attached thereto. The number of the weight sensors 24 may be four wherein each of the sensors is positioned in a corner area of the base plate 23. Also other numbers of weight sensors are possible such as three, or more than four. On the underside of the base plate 23 there is provided a controller 26 managing the communication and operation of the vending machine. In order to be able to do so, the controller 26 may be supplied with electrical power from an external source by means of a conventional power cable. Alternatively, an internal power source, for example rechargeable batteries, may be provided. The controller 26 may be connected to an actuator 27, a camera 28, the weight sensors 24 and the user interface 18. The controller 26 may basically be a personal computer including a processor and internal memory which stores necessary software and/or firmware components as well as data. Alternatively, the controller may be an application specific integrated circuit (ASIC), a field-programmable gate array (FPGA) or some other device configured or adapted specifically for the purposes of the present invention, but a generic computer device may provide more flexibility with respect to hardware (e.g. CPU power, memory and other components) and software changes (e.g. Linux, Windows) and high compatibility regarding the connected devices such as the camera 28. The controller 26 may provide the mentioned components (actuator, camera, weight sensors) with power by means of a cable and exchange data by means of a cable. The controller 26 may also communicate wirelessly with the components for exchanging data.

The actuator 27 is an actuator which can extend and retract telescopically, wherein one end of the actuator 27 is mounted to the pole 12 and the other end is mounted to the piston 20. In other words, a piston of the actuator 27 can telescopically extended from a cylinder of the actuator 27 and retracted into the cylinder of the actuator 27, which in turn telescopically moves the piston 20. The actuator 27 may be a low voltage actuator operable with for example 12 or 24V, which can be provided via, or under control of, the controller 26. One example of such an actuator 27 is the actuator LA22 from LINAK®. Regarding placement, the actuator 27 can be positioned entirely or partly inside the pole 12, which is holding the container 10. For operating the actuator, the controller 26 includes an actuator driving unit 29 which regulates e.g. the current which the actuator 27 is provided with. The driving unit 29 is operating the actuator 27 such that it shows characteristics like a soft start and a soft stop. One example for such an actuator driving unit 29 may be the TR-EM-208 from LINAK®.

On top of the weight sensors 24 there is placed a product plate 32 which is arranged such that it can freely move up and down along the longitudinal direction of the pole 12. Inside the container 10 and on the product plate 32, different products can be placed. This is illustrated in the example of FIG. 3 as a chocolate bar 30 and a beverage can 31. The product plate 32 and the weight sensors 24 are optional. The invention also includes embodiments without these, wherein in such a case, the products 30, 31 can be placed on the base plate 23 directly.

The camera 28 can be used both as deterrent against theft and for recognition of the products 30, 31 while the products 30, 31 are stored in the container 10 (the removed product is then the one which is not present anymore after the purchasing process) or during removal from the container 10. Product recognition will be described in further detail below. The camera 28 may be mounted inside the container 10 as illustrated in FIG. 3, in the upper end of the piston 20 (in particular in the upper surface of the piston 20), or in the curved part of the display holder 17 (underneath the tablet computer and directed towards the aperture). In FIG. 3, the camera 28 is positioned such that its angle of view can capture all of the products within the container 10. At least one camera 28 is necessary for visual recognition of products, but there could also be provided more than one camera 28. Having more cameras 28 may make the recognition of products more reliable and the overall angle of view wider, but may make an image processing more complex and slower. In the illustrated embodiment of FIG. 3, the camera 28 is provided within the container 10. However, as already mentioned, it would also be possible to attach the camera outside the container, namely mount it to the display holder 17, e.g. underneath the user interface 18 shown in FIG. 1, such that the camera is primarily directed towards the aperture 15 in order to capture images of the products while they are removed from the container 10 through the aperture 15. The camera 28 can also be integrated into the upper surface of the piston 20 and directed upwards, which would have the benefit that the products which are removed through the aperture 15 necessarily pass by in between the aperture 15 and the retracted piston 20 and would thus also pass by the upwardly arranged camera. This in turn would have the advantage that the camera is capturing the removed product from underneath (and on an opposite side to the hand of the user) making it unlikely that the hand of the user is covering the product to an extent which would negatively influence the product recognition.

The inside of the container 10 below the lid 14 and above the plane which is adapted to carry the products 30, 31 (the product plate 32 or the base plate 23) is free of dividing walls. Thus, a single continuous space is provided for storing the products 30, 31. This provides the benefit that the products 30, 31 can have any shape or size as long as they fit into the container 10 and through the aperture 15. Also, the products do not have to have a stable outer shell (e.g. a beverage can), but could be soft or flexible (e.g. a scarf or a softball). Due to omitting compartments or dividing walls within the container 10, the products 30, 31 do not have to be sorted or carefully stacked within a specific compartment. Many prior art vending machines require sorting of specific products in assigned compartments and some even require to stick the products into certain positions of a spiral which dispenses the products upon request. With the present invention, if for example softballs or golfballs are sold, refilling the vending machine simply requires removal of the lid 14 and the softballs can be dumped into the container 10 until it is full, which allows a very easy handling.

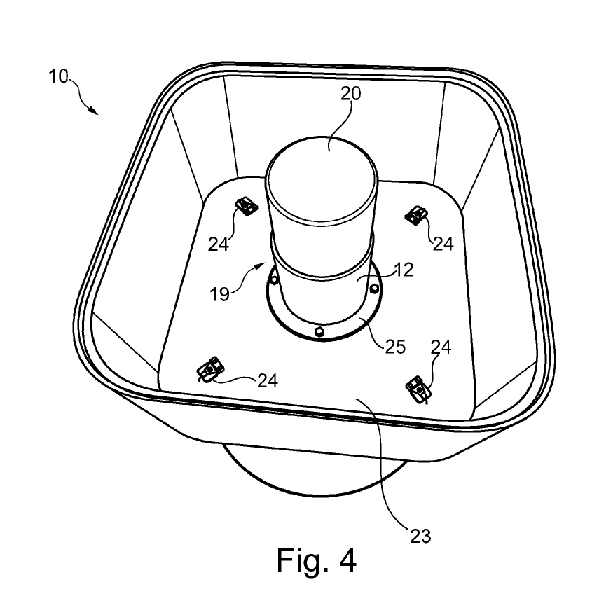

FIG. 4 shows a three-dimensional view from above into the container 10. This Figure shows the already described base plate 23 with the weight sensors 24 mounted thereon in all four corners and the attachment of the base plate 23 to the flange 25 of the pole 12 by means of screws. The product plate 32 is not illustrated in FIG. 4.

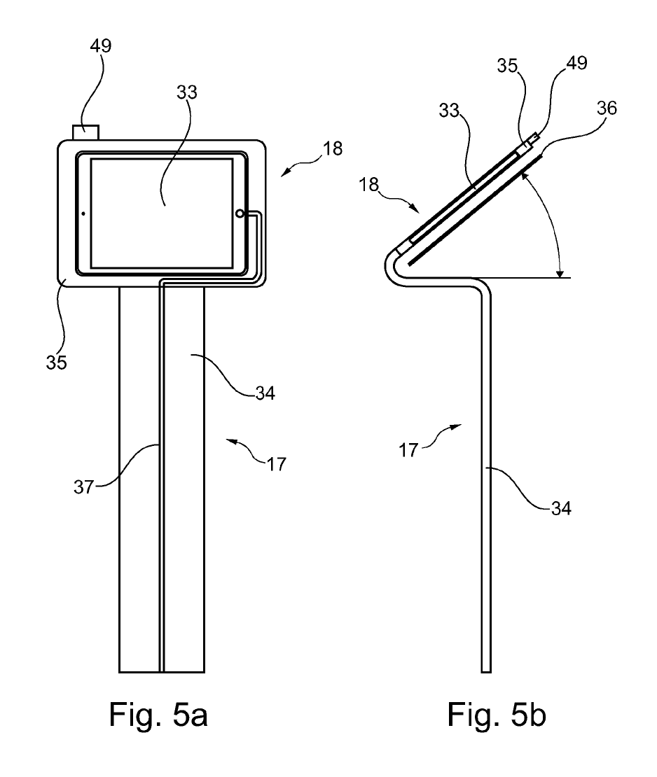

FIGS. 5a and 5b show the display holder 17 holding a tablet computer 33 as user interface 18. FIG. 5a shows basically a front view of the straightened display holder 17. As illustrated, the display holder 17 comprises a band-shaped leg 34 at the upper end of which a casing 35 is attached or monolithically formed with. The casing 35 is adapted to encase a tablet computer 33. FIG. 5b is a side view of the display holder 17 in a final shape. The leg 34 comprises (when attached to the container 10) in an area above the lid 14 a 90° curvature towards the aperture 15 and at a position at the lower end of the casing 35 a 145° curvature backwards. Reference numeral 36 indicates a cover for closing the casing 35 on the back side which may be lockable. The display holder 17 is made of acrylate polymer or polycarbonate. The display holder 17 could also be made of metal and bent into the shape as shown in FIG. 5b. Necessary cables 37 can be guided inside the display holder 17 through appropriate passages. The display holder 17 may be attached to the inside of the container 10, wherein for this purpose, the lid 14 may be provided with an appropriate recess. This way of attachment hides power cables and data cables leading to the controller and other components. Optionally, there may be provided a card reader 49 at the user interface 18, which is operatively connected to the user interface 18 (e.g. plugged into a tablet computer). The card reader 49 may be adapted to read payment cards (e.g. credit cards) or smart cards by way of magnetic stripes while the cards are swiped through the card reader 49, it may be adapted to read a chip of the cards while the cards are inserted into the card reader 49, or the card reader 49 may be an NFC reader. The card reader 49 may also be capable of reading an ID card of the user by scanning the ID card or by reading chip integrated into the ID card. A smart card may be a card provided by the vending machine manufacturer or the vending machine operator which is adapted to identify a user.

While the embodiments described above include a number of aspects consistent with the principles of the invention, many alternatives may be contemplated. For example, while the controller 26 is described as a computer controlling the sensors and the actuator, while the user interface 18 is described as a tablet computer which controls the display, communication with the user interface for user identification and payment handling, as well as network communication, which will be described in further detail below, it will be realized that these two computers could be combined into one, or they could be configured such that tasks were shared between them in a different manner than described above.

It will also be understood by those with skill in the art that the overall shape of the device can be different (for example circular, or even ball shaped like a globe). Also, the aperture may have a different position in the lid, and the closing mechanism can, for example, be in the form of a door that is hinged or a plate that is moved, or slides, parallel to the lid in order to open and close the aperture. In trusted environments it may even be contemplated that the aperture access enabling device 19 or closing device initiates an alarm that sounds if a user reaches inside the machine without first logging in or otherwise identifying themselves. The alarm may, for example, be operatively connected with one or more light sources (e.g. lasers) and corresponding light detectors configured such that the light from a light source will be prevented from reaching its corresponding light sensor if a hand is inserted into the machine. After identification of a user, the alarm may be disabled until a transaction has been completed.

The number of weight sensors required may also be reduced, even as low as to only one, provided that the product plate 32 can move freely and exert the same pressure onto the weight sensor irrespective of where in the machine a product is positioned.

Finally, it will also be understood that while compartments for separating different types of products have been described as unnecessary, the use of some sort of compartmentalization or subdivision of the space inside the machine is not inconsistent with the principles of the invention.

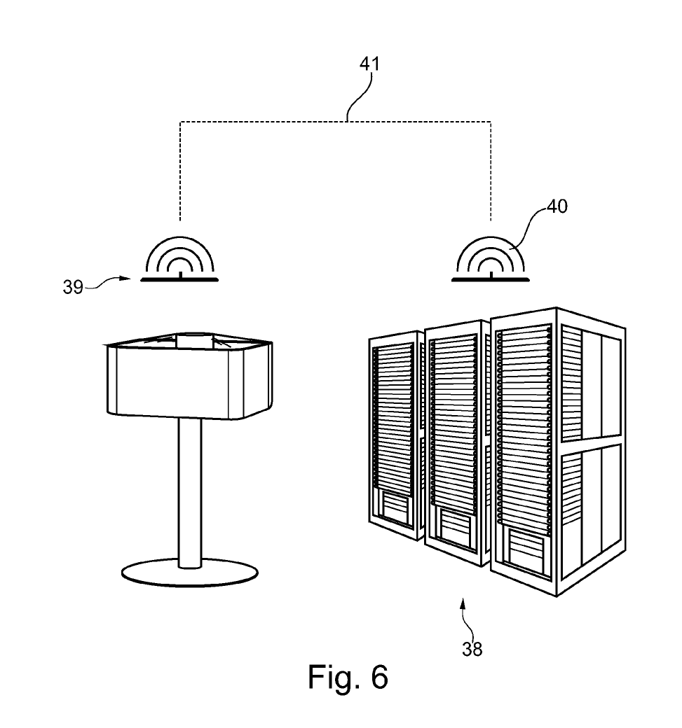

FIG. 6 shows schematically the communication ability of the vending machine with a remote server 38. For this purpose, the server 38 is connected to the internet and accessible by a plurality of vending machines via the internet. The vending machine establishes the connection to the internet (and thus to the server 38), by a network communication device 39 which may be included in the controller 26 or which may be included in the user interface 18, e.g. the communication interface of a tablet computer. The network communication device 39 and the user communication device 63 (FIG. 3) could be separate devices or the same device depending on the chosen kind of wireless communication (e.g. Wi-Fi, Bluetooth). The network communication device 39 may establish wireless communication 41 to a mobile communications network used by mobile phones, or establish wireless communication 41 to a Wi-Fi router 40 which is connected to the internet. The network communication device 39 could also establish such a communication in form or a wired communication. The communication with the remote server 38 allows central and server controlled pricing such that the prices of certain products can be changed centrally by means of the server 38 instead of changing these data at each of the vending machines. Further, the server 38 can provide the vending machines centrally with product information, e.g. product information that is given to the user or product information that relate to the purchasing process, such as data saved in a sample storage, which will be described in further detail below. The server 38 can further receive the inventory status of the vending machines such that it can be centrally determined when a vending machine needs to be refilled without spending time checking each vending machine regularly. Further, it enables central logging of sales, including the number already sold of each individual product.

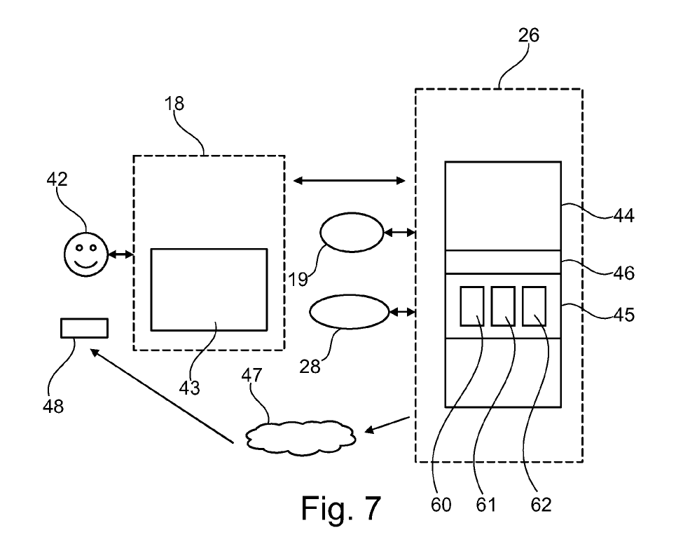

FIG. 7 shows a block diagram of a control scheme of the vending machine according to an embodiment of the present invention. Box 26 schematically illustrates the controller. The controller 26 may be running an operating system such as Windows or Linux and may be supported by Java. A user 42 may identify himself via the user interface 18 which can be the user's own mobile device, such as a mobile phone or a tablet computer (e.g. based on Android, Windows or iOS), or it can be a device attached or integral to the vending machine, such as a touch screen, a keyboard, a tablet computer or a combination of these. The identification can also be conducted by a combination of the above, for example via a cloud service 47, e.g. Twilio or Link Mobility. In such a case the cloud service 47 is a SMS-service which might be used for authorization in the login process. For example, when the user logs in on the touchscreen he enters his phone number, and cloud service 47 will send a SMS to that number with an authorizing code, and the user enters that code for authorization. It is used as a two-way authorization process. In case of the user interface 18 being the users own mobile device, there may be provided application software 43 which can be installed on the mobile device and which manages the communication between the mobile device of the user 42 and the vending machine. It is also possible to recognize the user 42 by means of face recognition using a camera of the user interface 18 (e.g. the tablet computer 33). Yet another alternative is to use a fingerprint reader installed as part of the vending machine or on the user's own mobile device. Thus, a user 42 identifies himself at the vending machine before a transaction process using his own mobile device (e.g. the user's personal phone's NFC), or in case of the user interface 18 being provided at the vending machine by entering a pin code, by inserting a smart card or his credit card into the card reader 49, or e.g. by face or fingerprint recognition. The user interface 18 may communicate with the controller 26 and other components such as the camera 28, the weight sensors 24 wireless (e.g. Wi-Fi or Bluetooth), i.e. communication between user interface and sensors is wireless. The controller 26 (or, optionally, the user interface device) verifies the identification by communicating with the remote server 38. After the approved identification, the controller 26 opens the aperture access enabling device 19 by means of the driving unit 29 which retracts the piston 20 into its opened position. The user 42 can then reach with his hand through the aperture 15 into the container 10 and remove one or more of the products 30, 31.

According to some embodiments, the controller may include a sample storage 44 which stores sample descriptions consisting of pictures with drawn outlines of the products 30, 31 to be sold. The sample image files stored in the sample storage 44 provide outlines and imprint images from different angles of the product. The sample files could be created for example by providing an imaginary sphere around the product which sphere is divided by a grid such as the longitude and latitude of the earth which grid lines are provided for example in intervals of 10° (or any other interval). Then from the angle of every intersection point of these grid lines an image is taken and from this image, an outline of the product and the imprint is saved. Thus, the sample storage 44 is also a database providing a comparison basis for a product recognition executed by a recognition module 45. The recognition module 45 executes recognition software 46 such as SentiSight® SDK. The modules mentioned here, can be hardware or hardware-software combinations. In order to recognize the products in the container 10 or in the vicinity of the aperture 15, the recognition module 45, in particular camera based object recognition module 60, receive image information from the camera 28 which can be a fixedly installed camera or which can be a controllable camera which can be moved (e.g. moved up, down, left and right) as directed by control signals from the controller 26, in order to enlarge the angle of view of the camera. The object recognition module 60 is adapted to recognize each of the products stored in the container 10 by comparing the image data from the sample storage 44 by means of the recognition software 46. In particular, the object recognition module 60 recognizes the products by comparing the outline (the shape) of the products with the stored samples and by comparing the imprint on the products with the stored samples. This way, the object recognition module 60 is capable of recognizing all the products 30, 31 present in the container 10 and determine which of the products has been removed when the purchasing process is finished, because this/these product(s) is/are not present inside the container 10 anymore. Or, in case the camera 28 is arranged in the vicinity of the aperture 15, the object recognition module 60 recognizes which of the products 30, 31 is removed out through the aperture 15. In addition to, or alternative to the image recognition described above, the recognition module 45 can identify which of the products 30, 31 is removed out of the container 10 during a purchasing process by determining the weight difference before and after the purchasing process by means of weight recognition module 61. For this purpose, the sample storage saves the weights of all products 30, 31 stored in the container 10. This weight recognition can be executed in addition to the image recognition in order to improve accuracy or it can be executed alternatively to the image recognition. Furthermore, in addition to at least one of the image recognition and the weight recognition, or alternatively thereto, the recognition module 45 can recognize the products 30, 31 removed from the container 10 based on RFID-technology by means of RFID recognition module 62. RFID is the abbreviation for radio-frequency identification, wherein identification tags are attached to the products 30, 31, which identification tags transfer data to a receiving module by means of electromagnetic fields. For this purpose, the sample storage saves the RFID data of all products 30, 31 stored in the container 10. The data received from the RFID tags can be compared to the sample data stored in the sample storage 44 in order to recognize the products 30, 31 as they are removed out through the aperture 15. An RFID reader would have to be placed near the aperture 15.

After the purchasing process, the user 42 indicates through the user interface 18 the end of the purchasing process and the controller 26 closes the aperture access enabling device 19. In order to give the user 42 appropriate feedback after the purchasing process is finished, the controller 26 initiates the sending of a text message via a cloud service 47, e.g. Twilio, to a mobile phone 48 associated with the user 42.

This mobile phone 48 may be the one which is used as user interface 18. Payment can be conducted by a payment method which is registered in the account of the user, by mobile payment (by means of the mobile phone) or by a credit card which is read by the card reader 49 (this can be the credit card which is also used to initially identify the user).

According to one aspect of the invention, the user 42 can indicate interests or preferences such that the user 42 receives additional messages, e.g. coupons which are personalized to his interests or preferences from the vending machine in addition to receiving the products 30, 31. As the products 30, 31 which the user 42 is buying or has bought before also indicate the interests of the user 42, it is possible to personalize the messages or coupons for the user 42 based on the current purchase and/or the purchase history of the user 42. The coupons can be personalized to age, gender, shopping interests, purchase history, vending machine location, home address, work address, etc., as well as any commercial campaign requested by an advertiser.

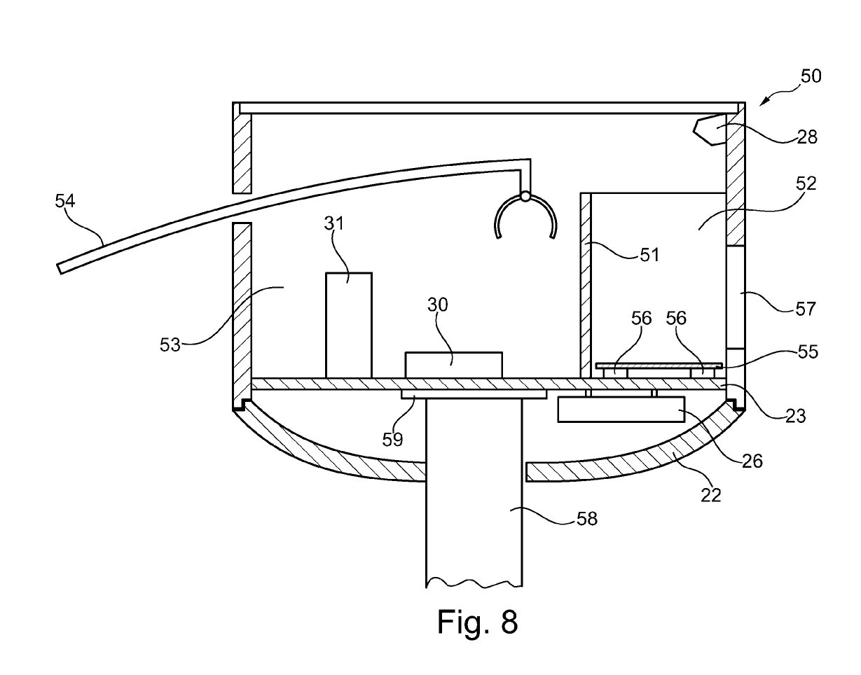

FIG. 8 shows another embodiment of the vending machine according to the present invention. In order to avoid repetitions, the above description shall apply also to this embodiment, and only aspects will be explained in which this embodiment is differs from the above explanation.

The lid of this embodiment corresponds to the lid 14, but without the aperture 15. The inside of the container 50 of this embodiment comprises a dividing wall 51 such that a delivery compartment 52 is formed which is separated by the dividing wall 51 from the rest of the inside of the container 50, which forms a product compartment 53. In a top view, the dividing wall 51 is fully separating the delivery compartment 52 from the product compartment 53, but the upper side of the delivery compartment 52 is opened as shown in FIG. 8. The dividing wall 51 is fixedly attached to the base plate 23 or monolithically formed with it. The products 30, 31 in the product space 53 can be moved by the user 42 by means of a manipulator arm 54 from the product space 53 to the delivery compartment 52. Alternatively, to the manipulator arm, there could be provided another manipulator device such as a manipulator crane. From the delivery compartment 52, the user can take the product out through a dispensing opening 57. As every product which is sold has to pass the way into the delivery compartment 52, it is sufficient to conduct the recognition of the product in or on the way into the delivery compartment 52. Therefore, the camera 28 is arranged such as to be directed towards the upper opened side of the delivery compartment 52. Also the product plate 55 only has to be provided in the delivery compartment 52 and corresponds apart from this to the product plate 32. Weight sensors 56 corresponding to the weight sensors 24 may be arranged underneath the product plate 55. As the aperture access enabling device 19 is not necessary in this embodiment, the upper end of a pole 58 can be attached to the underside of the base plate 23 by means of a flange 59.

While the manipulator arm 54 is shown as extending through the side wall of the machine, it could equally well be extending through the top lid. Furthermore, it could be contemplated to provide some form of a conveyor belt between the delivery compartment 52 and the product compartment 53. A user would then use the manipulator arm 54 to place a product on the conveyor, which would transport the product to the delivery compartment. While such a configuration would increase the number of movable parts, it would also give an unobstructed view of a selected product as seen from a camera 28 mounted above the conveyor.

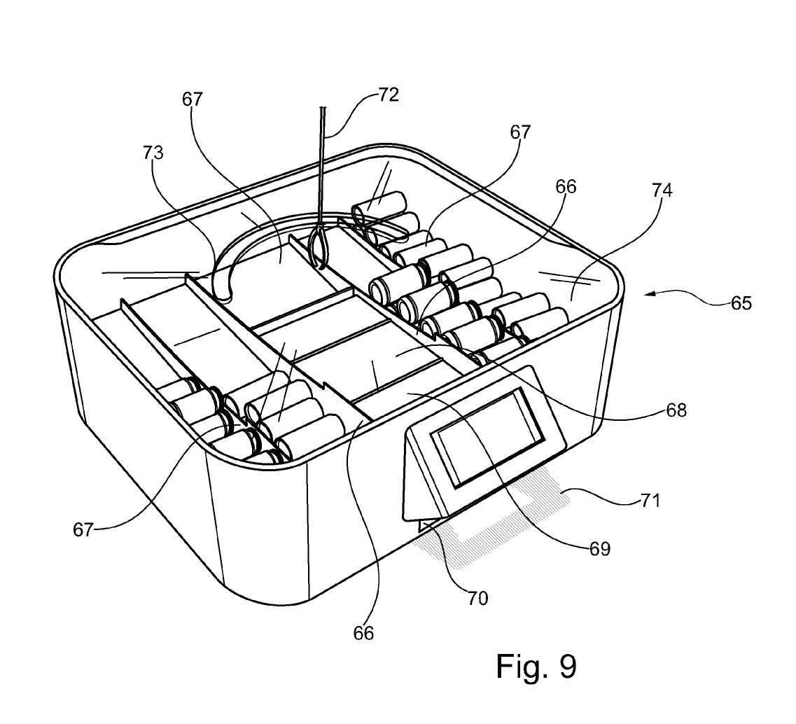

FIG. 9 shows another embodiment, in which the embodiment of FIG. 8 is modified. In order to avoid repetitions, only aspects are described in which this embodiment distinguishes from the one shown in FIG. 8.

A container 65 of this embodiment comprises dividing walls 66 which are dividing the inside of the container 65 into multiple product compartments 67 and a delivery compartment 68. The delivery compartment 68 is extending through an opening 70 which is provided in the side wall of the container 65. The part of the delivery compartment 68 within the container 65 is provided with a conveyer belt 69 and the part of the delivery compartment 68 outside the container 65 is formed as a collecting basket 71. The vending machine according to this embodiment may comprise a manipulator crane 72 which reaches through a curved gap 73 formed in a lid 74 through the lid 74. The lid 74 corresponds to the lid 14 with the exception that instead of the aperture 15, the curved gap 73 is provided. The manipulator crane 72 can be operated manually by the user in order to pick the desired product 30, 31 and to move the product from the product compartment 67 onto the conveyer belt 69. The conveyer belt 69 then moves the product from e.g. from a central position of the container to the opening 70 where the product is pushed by the conveyer belt/or rolls through the opening 70 into the collecting basket 71 where the user can take the product. As every product which is sold has to pass the way into the delivery compartment 68 or onto the conveyer belt 69, it is sufficient to conduct the recognition of the product in or on the way into the delivery compartment 68 as in the embodiment of FIG. 8.

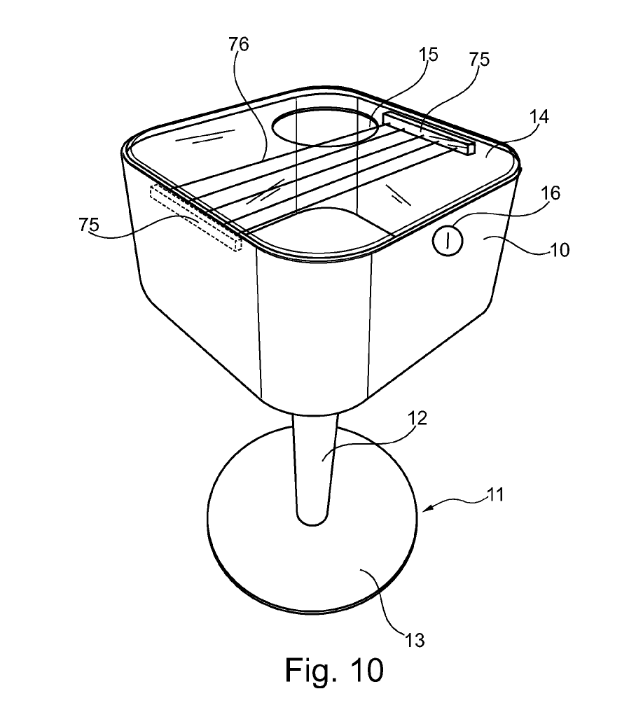

FIG. 10 shows another embodiment of the vending machine according to the invention. Compared to the embodiment shown in FIG. 1, the vending machine of this embodiment does not include the display holder 17 and the piston 20. The user interface of this embodiment is formed by the user communication device 63 which communicates with a mobile device of the user. The aperture access enabling device 19 in this embodiment is formed by a light barrier device 75 which comprises a light transmitter on a side wall and a light sensor on an opposite side wall, or which comprises a light transmitter-sensor on a side wall and a mirror on the opposite sidewall. The light barrier device 75 is capable of emitting several light beams (e.g. also including laser beams) along an array such that a plurality of parallel light beams 76 is emitted towards the opposite side wall where the sensor or the mirror of the light barrier device 75 is located. The light beams 76 may be colorful for an attractive appearance, and in order to be visible they may partly be directed towards a medium that will subject the light to diffuse reflection, e.g. plastic parts of the vending machine, or even an artificial mist (steam, a spray of droplets or something similar). The light beams 76 may also look like prison/sprinkler bars, visually blocking the hole. When access into the container 10 is enabled, the light barrier device 75 is turned-off. The light beams 76 thus are extending in parallel and horizontally underneath the aperture 15. When access into the container 10 is prohibited, the light barrier device 75 is turned on. In the turned on state, the light barrier device 75 can recognize the interruption of one or more of the light beams 76 and the vending machine can thus recognize an unauthorized access into the container 10. The aperture 15 is not physically blocked, but if the user, or any other person, puts his hand in through the aperture 15 without logging in, an alarm would go off and a picture would be taken of the user or person (in embodiments where the camera is directed towards the user). Thus, a user has to log in or otherwise be identified before being able to reach with his arm into the container 10. The user can log in with his mobile device, e.g. mobile phone, communicating with the vending machine with either NFC or other communication. After logging in, the aperture 15 would no longer be visually blocked with the light beams 76 and the user can reach through the aperture 15 into the container 10 of the vending machine and pick a product. The product is recognized by one or more of the recognition modules described before, e.g. with RFID and/or camera and/or a weight sensor. The purchase of the product will then be registered on the customer's account. This embodiment would have the benefit that without the screen and the actuator the cost would be reduced, and it could be good for places giving out coffee capsules or as an inventory control.

While this embodiment has been described as having no display or screen, it is consistent with the principles of the invention to include a display or screen, e.g. a tablet computer, in embodiments without the actuator or other physical blocking means.

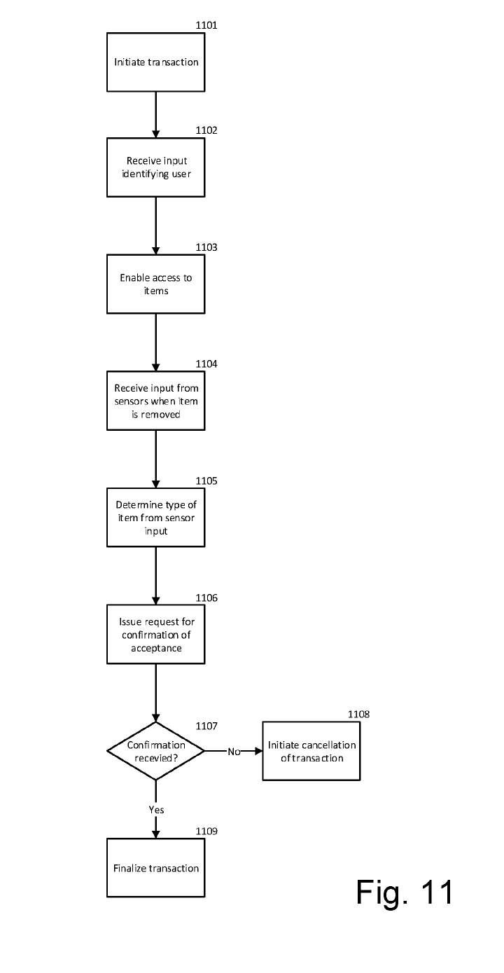

Reference is now made to FIG. 11, which illustrates an exemplary method that can be performed by a vending machine operating in accordance with the principles of the invention.

The method starts in an initialization step 1101. This step may be selected from many methods that are well known in the art, such as a user pushing an activation button, a proximity detector (e.g. a camera) detecting the presence of a user, etc. The step may also be merged with the following step 1102, in which user input identifying the user 42 is received from the user interface 18. In other words, the vending machine may first be initialized and present a prompt for user identification in an initialization step, or a user input of identification may serve as the initialization step.

The user interface 18 may be any combination of the devices and capabilities that have already been described, and for the purposes of the description of the purchase or transaction process, the user interface 18 will be considered as including any communication interface involved in the process of exchanging information with a user or an external device operated by the user. As such, the user interface 18 may be any combination of the tablet computer 33 or other display device integral to the vending machine, the card reader 49 (e.g. magnetic strip reader or smartcard reader), the camera 28, the user communication device 63 (e.g. a Bluetooth, Wi-Fi, NFC or other wireless interface capable of communicating directly with a device operated by the user), or network communication device 39 (e.g. wireless or wired communication with an external network, for example a cellular mobile network and intermediary devices including servers which in turn forward information to or from a device used by the user).

This means that the input received in step 1102 may be received as user input from a keypad or keyboard or touchscreen, from the card reader 49 reading user identity from a credit card or smartcard, it may be based on face recognition from camera input or fingerprint recognition from a fingerprint reader, user credentials received directly from a user device over the user communication device 63 or indirectly via the network communication device 39, for example as a text (SMS) message received from a cellular mobile network. Also, as described above, networked services such as Twilio or Link Mobility may be involved.

As soon as the user 42 is identified by the controller 26 based on the information received in step 1102, the aperture access enabling device 19 may enable access to the items in the vending machine in step 1103. The aperture access enabling device may be any of the devices described above configured to enable or prevent access to the products or items stored inside the vending machine, either physically by blocking the aperture 15, or logically preventing access by issuing an alarm if an attempt is made at accessing items without prior user identification.

After the aperture access enabling device 19 has enabled access, the controller 26 monitors input from the sensors that are configured to detect items that are removed from the container 10, 50, 65. As described above in connection with the recognition module 45, several types of sensors can be used either alone or in combination. Examples of sensors include one or more weight sensors 24, 56 that detect the weight of the item that has been removed, one or more cameras 28 that capture one or more images of the item that is being removed and subject the one or more images to an image recognition or feature extraction that is capable of detecting characteristic visual features of the item, and an RFID reader that can read an RFID tag attached to the item. When the controller 26 receives input from the sensors, the input can be analyzed and the type of item can be recognized in step 1105. This analysis and recognition can be based on a comparison of the received and analyzed sensor input with a catalog of characteristic features associated with respective items or products. This catalog can be stored in a database or some other data format in local memory in the vending machine. Alternatively, the information can be available from a remote server.

When the recognition has been made in step 1105, the controller may request a confirmation of acceptance from the user in step 1106. This request may be presented on a display of the vending machine (e.g. user interface mounted to the vending machine), or as a message transmitted directly or indirectly (e.g. over a mobile network or the Internet) to a device operated by the user to be displayed there. Included in the request for confirmation may be a price, or any other conditions the user must accept in order to keep the item. Such conditions may, for example, be to be included on a mailing list, or to be registered in a database of users maintained by a remote server.

Various embodiments of the invention may receive confirmation from the user in different ways. According to some embodiments, the user confirms using a graphical user interface, such as the tablet computer described above. Alternatively, or in addition, the user may have to enter payment information by swiping a credit card or causing a smart card or a card or other device with an embedded NFC tag to be read by a corresponding reader attached to the vending machine, as described above. Some or part of the confirmation information may also be received from a mobile device operated by the user, for example over Bluetooth, Wi-Fi or as SMS, or over the Internet, for example by operating a web browser installed on the mobile device.

The information received as confirmation may include credit card information from a card reader, mobile payment information from a mobile device associated with the identified user, information identifying a debit account associated with the identified user, and information confirming the identified user's acceptance to receive one or more messages from a set of messages stored remotely.

If confirmation is not received, for example within a predetermined time or a message of rejection is received instead, as determined in step 1107, the method proceeds to step 1108 where a cancellation is initiated. Cancellation may involve prompting the user to return the item to the container, registering that the item is indeed returned to the container (in a which is the reverse of the detection of removal of an item), and cancellation of all pending transaction steps. Otherwise, i.e. if confirmation is received (or if the item is not returned within a predetermined time limit), the transaction is finalized in step 1109. Finalization of the transaction may include transfer of funds by a payment service, registration of the user in a user database, or the implementation of any other conditions accepted by the user. Finalization may also include registration of data related to the transaction for bookkeeping and statistics purposes. The finalization may also include issuance of a receipt, a coupon or any other message related to the transaction. Such a message may be received immediately or delayed, and only once or repeatedly. For example, a remote server may include a set of available messages, and the message or messages sent to the user may be chosen from a subset of this set of messages, where the subset are messages that are selectable based on criteria associated with the removed item (i.e. with the one or more characteristics used to identify the item, or the identified item itself).

In particularly trusted environments, for example at a workplace, access to items may be permanently enabled or enabled without prior identification of the user. The identification step 1102 may then be combined with confirmation receipt in step 1107.

In addition to the features described above, the vending machine of all embodiments may be provided with the following features:

Cooling function: Optionally, the vending machine may be provided with a cooling function in order to cool the inside of the container.

Data analysis: As the vending machine makes it possible to acquire all kinds of data such as regarding the vending machine environment, the user and the product, it allows combining these data in order to achieve more sophisticated statistics and analysis. These results could be used for marketing purposes.

User data acquisition: In case of registered users, data regarding every user can be acquired. This allows individual user statistics, and also the user themselves provide user information during the web registration.

Social network integration: Do to the vending machines being connected to the remote server 38 and thus being connected to the world wide web, the vending machine allows a social network integration which means that user can share or forward offers, gifts or coupons to other users via social networks.

Eye tracker: The image processing can additionally comprise the feature to recognize and track the eyes of users and/or people looking at the vending machine. This allows determining where the user/people look at, in particular at which products they look at or at which advertising area on the vending machine they look at. Having this kind of information allows analyzing the attractiveness of packaging, advertisement, products, design etc. Thus, it would give feedback for marketing purposes which could be used for improving marketing.

Additional network cameras: In addition to the cameras described above, one or more additional cameras can be attached to the vending machine These cameras may be configured to capture a view of people passing through the area surrounding the vending machine. The cameras may be in communication with the vending machine and/or the remote server 38. Image processing capabilities located either in the camera itself, in the vending machine or in the server may be used to detect and count the number of people passing by the machine. Furthermore, face detection may be used to detect the number of people who actually look at the vending machine. This information may be used to analyze the attractiveness of the vending machine in various locations by analysis of whether the vending machine catches the attention of people passing by. In particular it may be possible to determine the fraction of passersby that look at the vending machine, and the fraction that actually choose to interact with the machine and complete a transaction. The network cameras could also be useful in protecting the vending machine from damage or theft.

Coupons: A further example on how coupons could be assigned to a user could be realized as described in the following: When the user logs in at the vending machine by means of his mobile phone using his phone number, the mobile phone number may be shared if the log in is conducted by means of NFC (with NFC the user's phone may share the phone number when swiping the phone). This way the vending machine saves the phone number after log in. When the user chooses his preferred value coupon there will be a short text explaining that the coupon is sent to an application software after the purchase. When the user logs out after the purchase he receives a text message with an internet link. The user can click the link and may be directed to a website. On the webpage the user may be asked to enter personal details, such as first name, last name, mail, etc. Thereafter, the user receives a link to download an application, and when the application is downloaded it automatically adds the above information to the personal profile of the user. Then the user receives the value coupon in the application and it can be used instantly.

Further, the disclosure of this invention includes the following aspects, and the applicant reserves the right to claim one or more of the aspects as follows:

A. Vending machine for selling products to a user, comprising:
a container for storing and displaying the products, the container having a transparent portion making the products visible from outside the container, and an aperture for removing one or more products by hand, wherein the aperture gives direct access to the products;
aperture access enabling device for selectively opening and closing the aperture;
recognition module for recognizing each of the products in the container.

B. Vending machine for selling products to a user, comprising:
a container for storing and displaying the products, the container having a transparent portion making the products visible from outside the container, and an aperture for removing one or more products by hand, wherein the aperture gives direct access to the products;
aperture access enabling device for selectively opening and closing the aperture;
recognition module for recognizing each of the products in the container, the recognition module comprising at least one from the group consisting of: camera based object recognition module, weight recognition module, a RFID recognition module.

C. Vending machine for selling products to a user, comprising:
a container having a product compartment for storing and displaying the products, the container having a transparent portion making the products visible from outside the container;
the container further comprising a delivery compartment which is accessible from outside the container via a dispensing opening;
a manipulator device which is operable by the user and by means of which the products can be transferred from the product compartment into the delivery compartment;
recognition module for recognizing each of the products.

D. Vending machine according to aspect C, wherein there is a diving wall provided in between the delivery compartment and the product compartment.

E. Vending machine according to aspect A or B, wherein a lid is loosely covering the container and removable when a lock is opened, which is selectively locking the lid to the container.

F. Vending machine according to any one of the aspects A, B or E, further comprising an actuator driving unit which is supplying an actuator for operating the aperture access enabling device with power and which is operating the actuation of the actuator.

G. Vending machine according to any one of the aspects A, B, E or F, further comprising a card reader for reading a payment card (e.g. credit card), a smart card or an ID card of the user.

H. Method for operating a vending machine for selling products to a user, the vending machine comprising a container having a product compartment for storing and displaying the products, the container having a transparent portion making the products visible from outside the container; the container further comprising a delivery compartment which is accessible from outside the container via a dispensing opening;
recognition module for recognizing each of the products while transferred from the product compartment into the delivery compartment, or while the product is located in the delivery compartment.

The above mentioned aspects can be combined with one or more of the claims. Further, it is explicitly intended that the teaching of this invention covers any combination of the above described embodiments.

While the invention has been illustrated and described in detail in the drawings and foregoing description, such illustration and description are to be considered illustrative or exemplary and not restrictive and it is not intended to limit the invention to the disclosed embodiments. The mere fact that certain measures are recited in mutually different dependent claims does not indicate that a combination of these measures cannot be used advantageously.

### LIST OF REFERENCE SIGNS

10 container
11 stand
12 pole
13 ground plate
14 lid
15 aperture
16 lock
17 display holder
18 user interface
19 aperture access enabling device
20 piston
21 side walls
22 bottom cover
23 base plate
24 weight sensors
25 flange
26 controller
27 actuator
28 camera
29 driving unit
30 chocolate bar
31 beverage can
32 product plate
33 tablet computer
34 leg of display holder
35 casing
36 cover
37 cables
38 remote server
39 network communication device

### 40 Wi-Fi Router

41 wireless communication
42 user
43 application software
44 sample storage
45 recognition module
46 recognition software
47 cloud service
48 mobile phone
49 card reader
50 container
51 dividing wall
52 delivery compartment
53 product compartment
54 manipulator arm
55 product plate
56 weight sensor
57 dispensing opening
58 pole
59 flange
60 camera based object recognition module
61 weight recognition module
62 RFID recognition mean
63 user communication device
65 container
66 dividing wall
67 product compartment
68 delivery compartment
69 conveyer belt
70 opening
71 collecting basket
72 manipulator crane
73 gap
74 lid
75 light barrier device
76 light beam

1. A vending machine for selling or dispensing products to a user, comprising:
a container for storing and displaying the products, the container having a transparent portion making the products visible from outside the container, and an aperture for removing one or more products by hand;
characterized in that it further comprises
an aperture access enabling device for selectively enabling or preventing access through the aperture into the container;
a recognition module for recognizing each of the products in the container, the recognition module comprising at least one from the group consisting of: a camera based object recognition module, and a weight recognition module;
wherein the recognition module is configured to identify a product upon its removal from the vending machine when the aperture access enabling device enables access to the products, and
wherein the aperture gives direct access to the products.

2. The vending machine according to claim 1, further comprising at least one camera,
wherein the recognition module comprises at least a camera based object recognition module which is operatively connected with the camera; and
wherein the camera based object recognition module is adapted to recognize the products by comparing output data from the camera, including at least one of a shape, a color and an imprint, with data stored in a sample storage.

3. The vending machine according to claim 1, further comprising a network communication device for operatively connecting the vending machine with a remote server.

4. The vending machine according to claim 1, only comprising a single aperture for removing one or more products.

5. The vending machine according to claim 1, wherein the aperture access enabling device is a piston, which closes the aperture by telescopically extending out from a cylindrical guidance towards or into the aperture and which opens the aperture by telescopically retracting from its extended state.

6. The vending machine according to claim 1, wherein the aperture access enabling device comprises a light barrier device for selectively establishing one or more light beams as a light barrier and for detecting an interruption of at least one of this one or more light beams, and an alarm device for outputting an alarm signal if such an interruption is detected.

7. The vending machine according to claim 1, comprising a user interface by means of which a user is identifiable.

8. The vending machine according to claim 7, wherein the user interface includes at least one of a touch screen, a tablet computer, a keyboard, a card reader, a camera, a fingerprint reader and a user communication device for communicating with a mobile device operated by the user.

9. The vending machine according to 7, wherein the user interface is adapted to identify the user by means of face recognition.

10. The vending machine according to claim 1, wherein an entire maximum space inside the container, which space is adapted for storing the products, is a single undivided space.

11. A method for operating a vending machine for selling or dispensing products to a user, the vending machine comprising a container for storing and displaying the products, the container having a transparent portion making the products visible from outside the container, and an aperture for removing one or more products by hand, wherein the aperture gives direct access to the products;
the method, comprising:
operating an aperture access enabling device for selectively enabling or preventing access through the aperture into the container;
recognizing the products in the container when removed from the container by means of at least one recognition method selected from the group consisting of: a camera based object recognition, and a weight recognition.

12. The method according to claim 11, wherein the recognition method includes camera based recognition and the camera based object recognition module recognizes products by comparing output data from the camera with data stored in a memory of the vending machine, said data including at least one of a shape, a color and an imprint which is representative of the respective products.

13. The method according to claim 11, further comprising the step of
identifying a user of the vending machine by at least one identification method selected from the group consisting of: facial recognition, finger print recognition, recognition of a mobile device associated with the user, login via password, login via credit card, login via smart card.

14. The method according to claim 11, further comprising the steps of collecting data with related to the environment of the vending machine,
the user and the sold products, and
combining these data.

15. The method according to claim 11, further comprising the step of tracking the eyes of the user and/or people passing by the vending machine.

16. The method according to claim 11, further comprising the step of dispensing coupons from the vending machine which are personalized to the user.

17. A method of performing a transaction in a vending machine, said vending machine comprising a container for storing products, the container having a transparent portion through which the stored products are visible from outside of the container, and an aperture for removing one or more products by hand, an aperture access enabling device for selectively enabling or preventing free access through the aperture when engaged, a user interface, at least one sensor configured to detect at least one characteristic of a product which is removed from the container, and a processor programmed perform the method, said method including:
receiving data from the user interface, said input identifying a user;
enabling access through the aperture;
upon removal of a product from said container, receiving data from said at least one sensor representative of or including the at least one characteristic;
issuing a request for confirmation of acceptance of the transaction to said user interface;
and
upon receiving input from said user interface representing the identified user's acceptance, performing said transaction and preventing access through the aperture.

18. A method according to claim 17, wherein said user interface includes at least one device chosen from the group consisting of: a camera, a touch screen, a card reader, a user communication device, and an NFC reader; and
said data identifying a user is an image of the user's face, a username and password, data read from a credit card or a smart card, data received from a mobile device associated with the user, data read from an NFC tag associated with the user or data.

19. The method according to claim 17, wherein said aperture access enabling device logically closes the aperture by activating a detector mechanism which is capable of issuing an alarm when detecting that an object is entered through said aperture.

20. The method according to claim 17, wherein said aperture access enabling device physically closes said aperture by activating an actuator that moves a door into a position which partly or fully blocks said aperture.

21. The method according to claim 20, wherein said door is one of the top of a cylinder or piston which telescopically moves toward said aperture, a hinged door which turns on said hinges into a closed position, and a lid which slides or rotates into a closed position.

22. The method according to claim 17, wherein said at least one sensor is chosen from the group consisting of: a weight sensor, a camera, and an RFID reader; and said at least one characteristic is a weight, an image representative of an outline, and image representative of a color, an image representative of an imprint, and data read from an RFID tag attached to the product.

23. The method according to claim 17, wherein said request for confirmation of acceptance is chosen from the group consisting of: a text shown on a display which is part of said user interface, a text which is transmitted over said user interface to a mobile device associated with said user.

24. The method according to claim 17, wherein said input from said user interface includes at least one of: credit card information from a card reader, mobile payment information from a mobile device associated with the identified user, information identifying a debit account associated with the identified user, and information confirming the identified user's acceptance to receive one or more messages from a set of messages stored remotely.

25. The method according to claim 24, wherein said input from said user interface includes said information confirming the identified user's acceptance to receive one or more messages; and wherein said messages are chosen from a subset of said set of messages, said subset being messages that are selectable based on criteria associated with said detected at least one characteristic.

26. The method according to claim 17, further comprising:
processing said data representative of the detected at least one characteristic to determine the type of product based on comparisons with stored data representative of characteristic features of the types of products stored in the container;
including with said request for acceptance a price of said identified product; and
including with the performance of said transaction a request that an amount corresponding to said price be transferred from an account associated with said identified user to an account associated with a vendor.
